(19) United States
(12) Patent Application Publication
(10) Pub. No.: US 2024/0339656 A1
(43) Pub. Date: Oct. 10, 2024

(54) SOLID ELECTROLYTE AND METHOD OF PRODUCTION

(71) Applicant: Solid Power Operating, Inc., Louisville, CO (US)

(72) Inventors: Brian E. FRANCISCO, Arvada, CO (US); Samuel M. OBERWETTER, Lafayette, CO (US)

(21) Appl. No.: 18/627,356

(22) Filed: Apr. 4, 2024

Related U.S. Application Data
(60) Provisional application No. 63/457,087, filed on Apr. 4, 2023.

(51) Int. Cl. H01M 10/0562; C01B 25/14

(52) U.S. Cl. CPC H01M 10/0562; C01B 25/14; C01P 2002/52; C01P 2002/72; C01P 2006/40; H01M 2300/008

(57) ABSTRACT

A process for preparing a solid electrolyte that includes mixing a lithium source with a sulfur source and a compound containing phosphorous and sulfur to form a composite, then heating the composite to the melting point of the compound containing phosphorous and sulfur to form the solid electrolyte material. A solid electrolyte material prepared by the process, wherein the solid electrolyte material is of formula I, which is Li_{(7-y-z)}PS_{(6-y-z)}X_{(y)}W_{(z)} wherein X and W are individually selected from F, Cl, Br, and I; where y and z each individually range from 0 to 2; and where y+z ranges from 0 to 2.

### CROSS-REFERENCE TO RELATED APPLICATION

This application is related to and claims priority under 35 U.S.C. § 119(e) from U.S. Patent Application No. 63/457,087 filed Apr. 4, 2023, titled “Solid Electrolyte and Method of Production,” the entire contents of which is incorporated herein by reference for all purposes.

### TECHNICAL FIELD

The present disclosure relates to methods for producing electrolyte materials, and therefore encompasses the fields of chemistry, chemical engineering, and electrical engineering.

### BACKGROUND AND INTRODUCTION

Advancing battery technologies is paramount to meet the ever-increasing adoption of mobile devices, electric automobiles, and the development of Internet-of-Things devices; therefore, the need for battery technologies with improved reliability, capacity (Ah), thermal characteristics, lifetime, and recharge performance has never been greater. Solid-state battery cells utilize nonflammable, solid electrolyte in contrast to the flammable, liquid electrolyte used in traditional batteries. Thus, solid-state battery cells are safer for use in comparison to traditional batteries. However, there are issues with currently available solid-state battery cells, such as shorting of the cell, increased cell resistance, and low specific cell capacity. In addition, solid-state battery cells can be costly to produce because the raw materials are expensive, and the manufacturing process takes a great deal of time while requiring a significant amount of energy to complete. To overcome these problems, a novel process for synthesizing a solid electrolyte for use in solid-state battery cells has been developed, which is described herein.

### SUMMARY

Provided herein is a solid-state composition of Formula (I):

Li_{(7-z-w)}A_{β}PS_{(6-z-w)}X_{z+β}Y_{w} (I);

wherein X and Y are independently selected from a group consisting of F, Cl, Br, and I; A is selected from a group consisting of Na, K, Cs, Fr, and a combination thereof, and 0≤z≤2 and 0≤w≤2, where z+w≤2, and 0≤δ≤0.100. In some embodiments, the composition comprises an argyrodite crystal structure.

In some embodiments, 0<β≤0.070, or 0<β≤0.050, or 0<β≤0.045, or 0<β≤0.035, or 0<β≤0.030, or 0<β≤0.020, or 0<β≤0.010, or 0.010≤β≤0.070, or 0.020≤β≤0.090, or 0.050≤β≤0.100.

Further provided herein is a solid state composition comprising Li₃Na_{y}PS₄Cl_{y}, Li₇Na_{y}PS₆Cl_{y}, Li₇Na_{y}P₃S₁₁Cl_{y}, Li₄Na_{y}PS₄XCl_{y}, Li₆Na_{y}PS₅XCl_{y}, Li₇Na_{y}P₂S₈XCl_{y}, or a combination thereof, wherein X is at least one halogen selected from the group consisting of F, Cl, Br, and I, and 0<y≤0.100. In some aspects, the composition comprises an argyrodite crystal structure.

Further provided herein is a solid-state composition of A solid-state composition of Formula (II):

Li_{(3β+7-z-w)}PS_{(6-z-w)}O_{β}Cl_{(β+z)}Y_{w} (II);

wherein Y is at least one halogen selected from a group consisting of F, Cl, Br, I, and a combination thereof, 0≤z≤2, 0≤w≤2, z+w≤2; and, 0<β≤0.100. In some aspects, the composition comprises an argyrodite crystal structure.

In some embodiments, 0<β≤0.070, or 0<β≤0.050, or 0<β≤0.045, or 0<β≤0.035, or 0<β≤0.030, or 0<β≤0.020, or 0<β≤0.010, or 0.010<β≤0.070, or 0.020<β≤0.090, or 0.050≤β≤0.100.

Further provided herein is a solid state composition comprising Li_{(3+3y)}PS₄O_{y}Cl_{y}, Li_{(7+3y)}PS₆O_{y}Cl_{y}, Li_{(7+3y)}P₃S₁₁O_{y}Cl_{y}, Li_{(4+3y)}PS₄O_{y}XCl_{y}, Li_{(6+3y)}PS₅O_{y}XCl_{y}, Li_{(7+3y)}P₂S₈O_{y}XCl_{y}, or a combination thereof, wherein X is at least one halogen selected from the group consisting of F, Cl, Br, and I, and 0<y≤0.100. In some aspects, the composition comprises an argyrodite crystal structure.

Further provided herein is a method of preparing a solid-state composition, comprising contacting Li₂S, P₂S₅, LiCl, and an alkali metal salt (AY) thereby forming a solid-state composition; and heat treating the solid-state composition, wherein the composition comprises an argyrodite crystal structure.

Further provided herein is a method of preparing a solid-state composition, comprising contacting Li₂S, P₂S₅, LiCl, and Li₃OCl, thereby forming a solid-state composition; and heat treating the solid-state composition, wherein the composition comprises an argyrodite crystal structure.

Further provided herein is an electrochemical cell electrochemical cell comprising one or more compositions of Formula (I) or Formula (II) described herein. The electrochemical cell comprises a positive electrode (i.e. cathode) current collector; a positive electrode layer (i.e. cathode layer) having a first side in operable contact with the cathode current collector and a second side opposite to the first side, a separator layer having a first side in operable contact with the second side of the cathode layer and a second side opposite to the first side, a negative electrode layer (i.e. anode layer) having a first side in operable contact with the second side of the separator layer, and a second side opposite to the first side, and a negative electrode (i.e. anode) current collector in operable contact with the second side of the anode layer. One or more of the positive electrode layer, the separator layer, and the negative electrode layer may include one or more compositions of Formula (I) or Formula (II).

### BRIEF DESCRIPTION OF DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 shows an X-ray Diffraction pattern of compositions of the present disclosure.

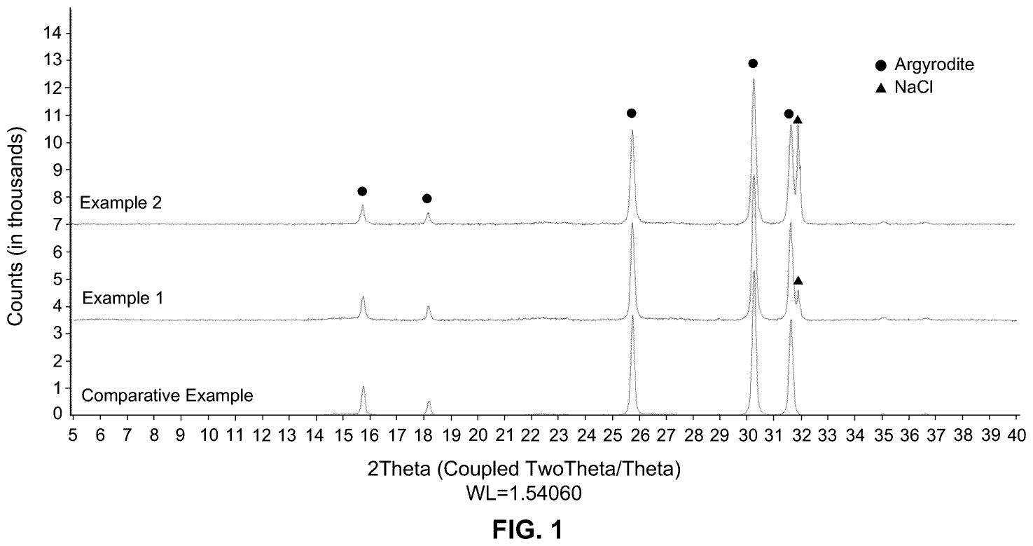

### DETAILED DESCRIPTION

In the following description, specific details are provided to impart a thorough understanding of the various embodiments of the disclosure. Upon having read and understood the specification, claims, and drawings hereof, however, those skilled in the art will understand that some embodiments of the disclosure may be practiced without hewing to some of the specific details set forth herein. Moreover, to avoid obscuring the disclosure, some well-known methods, processes, devices, and systems finding application in the various embodiments described herein are not disclosed in detail.

The present invention features a process for preparing a solid electrolyte material. The process may comprise: a) mixing one or more lithium sources with an alkali metal salt having the formula AY (wherein A is selected from the group consisting of Na, K, Cs, Fr, and a combination thereof, and Y is selected from F, Cl, Br, I, and a combination thereof), and a compound containing phosphorus and sulfur to form a solid-state composition; and b) heat treating the solid-state composition to form the solid electrolyte material. The lithium source, alkali metal salt, and the compound containing phosphorus and sulfur may be individually or collectively referred to herein as “precursors” or “precursor materials”. The solid electrolyte material may comprise an argyrodite crystal structure. In one embodiment, the process may further comprise simultaneously mixing the composite while heating. Preferably, the processes described herein may be performed in less than 5 hours to prepare a solid electrolyte material.

In some embodiments, the mixing in step a) forms a homogenous composite. As used herein, a “homogenous composite” is understood to refer to a composite material wherein all or substantially all of the components of the composite material (i.e., the precursors) are approximately evenly distributed throughout the composite material. Mixing the materials to form a homogeneous composite ensures an even distribution of all materials, which allows the materials to react in the appropriate ratios. Mixing during the heating step may also help to ensure uniform reaction. Additionally, mixing during the reaction may prevent a buildup of gases. For example, materials such as Li₂CO₃ give off CO₂. In other embodiments, the gases may include SO₂, H₂S, and other gases. The mixing may help to break up any surface tension of the molted flux mixture to allow for all gasses to escape before they react with any of the materials.

The mixing in step a) may be accomplished by methods generally known in the art. In some embodiments, agitators including agitated media mills, twin screw compounders, and other high shear equipment may be used to mix the materials to form a homogeneous composite.

The mixing in step a) may further comprise milling the homogeneous composite to a desired particle size. The milling may include wet milling or dry milling. The homogeneous composite may be milled for a predetermined period of time at a predetermined temperature to achieve a desired particle size. The milling may be accomplished using an attritor mill, an autogenous mill, a ball mill, a planetary ball mill, a buhrstone mill, a pebble mill, a rod mill, a semi-autogenous grinding mill, a tower mill, a vertical shaft impactor mill, or other milling apparatuses known in the art. Preferably, the milling is accomplished in a planetary ball mill or an attritor mill.

Mixing time and milling time is not specifically limited as long as it allows for appropriate homogenization and reaction of the precursors to generate the solid electrolyte material. The mixing temperature is also not specifically limited as long as it allows for appropriate mixing and is not so high that a precursor enters the gaseous state or prematurely forms a molten reactive flux as described further herein. The mixing and milling may be accomplished in an inert atmosphere, a moisture-free atmosphere, or an ambient atmosphere.

The mixing and/or milling may be accomplished without the use of a solvent; i.e., the mixing and/or milling may be solvent-free. Alternatively, the mixing and/or milling may take place in the presence of a solvent. The solvent may include an alkane, a blend of alkanes, xylene (including para-, meta-, and ortho-xylene), toluene, benzene, heptane, octane, decalin, 1,2,3,4-tetrahydronaphthalene, or combinations thereof.

In another embodiment, the composite may be heated in step b) to a temperature from about 150° C. and about 600° C. The composite may be heated in step b) to a temperature from about 150° C. to about 200° C., about 150° C. to about 250° C., about 150° C. to about 300° C., about 150° C. to about 350° C., about 150° C. to about 400° C., about 150° C. to about 450° C., about 150° C. to about 500° C., about 150° C. to about 550° C., about 150° C. to about 600° C., about 200° C. to about 600° C., about 250° C. to about 600° C., about 300° C. to about 600° C., about 350° C. to about 600° C., about 400° C. to about 600° C., about 450° C. to about 600° C., about 500° C. to about 600° C., about 550° C. to about 600° C., about 200° C. to about 400° C., about 200° C. to about 350° C., or about 250° C. to about 350° C. As an example, the composite may be heated in step b) to a temperature of about 150° C., about 175° C., about 200° C., about 225° C., about 250° C., about 275° C., about 300° C., about 325° C., about 350° C., about 375° C., about 400° C., about 425° C., about 450° C., about 475° C., about 500° C., about 525° C., about 550° C., about 575° C., or about 600° C. In some examples, the composite may be heated in step b) to about 172° C., about 288° C., or about 408° C.

Alkali metal salts of the present disclosure may generally have the formula AY, wherein A is selected from the group consisting of sodium (Na), potassium (K), cesium (Cs), francium (Fr), and combinations thereof, and wherein Y is selected from the group consisting of fluorine (F), chlorine (Cl), bromine (Br), iodine (I), and combinations thereof.

Exemplary lithium sources may include one or more of Li₂S, Li₂CO₃, a lithium halide, a lithium pseudohalide, Li₂O, Li₃PO₄, LiBO₂, Li₂B₄O₇, Li₂ZrO₃, LiAlO₂, Li₂TiO₃, LiNbO₃, and Li₂SiO₃, or a mixture thereof. Exemplary lithium halides may include one or more of LiF, LiCl, LiBr, and LiI, while exemplary lithium pseudohalides may include LiNO₃, LiOH, Li₂SO₃, Li₂SO₄, Li₃N, Li₂NH, LiNH₂, LiBF₄, and LiBH₄.

Exemplary compounds containing phosphorus and sulfur may include, for example, P₄S_{X} (where x ranges from 3 to 40) and P₂S₅. In an embodiment, phosphorus sulfide (P₄Sₓ) comprises mixtures of P₄Sₓ, where x ranges from 3 to 10, and may be a combination of P₄S₃, P₄S₄, P₄S₅, P₄S₆, P₄S₇, P₄S₈, P₄S₉, P₄S₁₀, and P₄Sₓ where x is a non-integer. In another embodiment, phosphorus sulfide (P₄Sₓ) comprises mixtures of P₄Sₓ, where x ranges from 11 to 14. The compounds containing phosphorus and sulfur may have a low melting temperature. As used herein, a low melting temperature is defined as a melting temperature of less than 300° C., such as 250° C. or less, 200° C. or less, or 150° C. or less.

The methods may further comprise mixing one or more sulfur sources with the one or more lithium source, the compound containing phosphorus and sulfur, and the alkali metal salt. Exemplary sulfur sources may include, for example, elemental sulfur, sulfur vapor (i.e., elemental sulfur heated above its sublimation or boiling point), a polysulfide, (NH₄)₂S, or H₂S gas. Non-limiting examples of polysulfides that may be used as the sulfur source include lithium polysulfide, sodium polysulfide, and potassium polysulfide. In an embodiment, the sulfur source is lithium polysulfide, such as Li₂Sₓ, where x is between 2 and 10. In embodiments where the sulfur source includes sulfur vapor, or H₂S gas, the sulfur vapor, or H₂S gas may be bubbled through or over the composite as heat is applied and the reaction is taking place. Alternatively, in embodiments where the sulfur source includes elemental sulfur, the elemental sulfur may be added directly to the composite mixture as a dry powder, a slurry, a solution, or a combination thereof.

The molar ratio of phosphorus to lithium to sulfur (P:Li:S) may be selected such that the reaction produces a desired solid electrolyte material. The molar amount of phosphorus in the molar ratio may be selected from about 1 to about 4, such as from about 1 to about 2, from about 1 to about 3, from about 2 to about 3, from about 2 to about 4, or from about 3 to about 4. In some examples, the molar amount of phosphorus in the molar ratio may be 1, 1.5, 2, 2.5, 3, 3.5, or 4. The molar amount of lithium in the molar ratio may be selected from about 1 to about 9, such as from about 1 to about 3, from about 1 to about 5, from about 1 to about 7, from about 3 to about 5, from about 3 to about 7, from about 3 to about 9, from about 5 to about 7, from about 5 to about 9, or from about 7 to about 9. In some examples, the molar amount of lithium in the molar ratio may be 1, 1.5, 2, 2.5, 3, 3.5, 4, 4.5, 5, 5.5, 6, 6.5, 7, 7.5, 8, 8.5, or 9. The molar amount of sulfur in the molar ratio may be selected from about 3 to about 12, such as from about 3 to about 6, from about 3 to about 9, from about 3 to about 12, from about 6 to about 9, from about 6 to about 12, or from about 9 to about 12. In some examples, the molar amount of sulfur in the molar ratio may be 3, 3.5, 4, 4.5, 5, 5.5, 6, 6.5, 7, 7.5, 8, 8.5, 9, 9.5, 10, 10.5, 11, 11.5, 12, 12.5, or 13. Thus, the molar ratio of phosphorus to lithium to sulfur may be 1-4:1-9:3-12.

In some exemplary embodiments, the methods comprise preparing the solid-state composition by contacting Li₂S, P₂S₅, LiCl, and an alkali metal salt (AY) to form the solid-state composition, followed by heat treating the solid-state composition.

In other exemplary embodiments, the methods comprise preparing the solid-state composition by contacting Li₂S, P₂S₅, LiCl, and Li₃OCl to form the solid-state composition, followed by heat treating the solid-state composition.

The process described herein may be used to prepare a solid electrolyte material of Formula I:

Li_{(7-z-w)}A_{β}PS_{(6-z-w)}X_{z+β}Y_{w} (I);

where X and Y are each individually selected from F, Cl, Br, and I; A is selected from the group consisting of Na, K, Cs, Fr, and a combination thereof; w and z each range from 0 to 2; w+z ranges from 0 to 2; and R ranges from 0 to 0.100. Exemplary solid electrolyte materials prepared by the process described herein may include, for example, Li₆PS₅Cl, Li₆PS₅Cl_{0.5}Br_{0.5}, Li_{5.5}PS_{4.5}Cl_{1.5}, Li_{5.5}PS_{4.5}ClBr_{0.5}, Li₆Na_{0.0608}PS₅Cl_{1.0608}, Li_{3.0858}PS₄O_{0.0286}Cl_{0.0286}, and Li₅PS₄Cl₂. The solid electrolyte material may be crystalline, glassy, or a glassy-ceramic.

In some embodiments, z may range from 0 to 2. For example, z may be about 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or about 2.0. In some aspects, z may be from about 0 to about 0.5, about 0 to about 1, about 0 to about 1.5, about 0 to about 2, about 0.5 to about 2, about 1 to about 2, or about 1.5 to about 2.

In some embodiments, w may range from 0 to 2. For example, w may be about 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or about 2.0. In some aspects, w may be from about 0 to about 0.5, about 0 to about 1, about 0 to about 1.5, about 0 to about 2, about 0.5 to about 2, about 1 to about 2, or about 1.5 to about 2.

In some embodiments, β may range from 0 to 0.100. For example, β may be about 0, 0.001, 0.005, 0.010, 0.015 0.020, 0.0250, 0.030, 0.0350, 0.040, 0.045, 0.050, 0.055, 0.060, 0.065, 0.070, 0.075, 0.080, 0.085, 0.090, 0.095, or about 0.100. In some aspects, R may be from about 0 to about 0.001, about 0 to about 0.005, about 0 to about 0.010, about 0 to about 0.015, about 0 to about 0.020, about 0 to about 0.0250, about 0 to about 0.030, about 0 to about 0.035, about 0 to about 0.040, about 0 to about 0.045, about 0 to about 0.050, about 0 to about 0.055, about 0 to about 0.060, about 0 to about 0.065, about 0 to about 0.070, about 0 to about 0.075, about 0 to about 0.080, about 0 to about 0.085, about 0 to about 0.090, about 0 to about 0.095, about 0 to about 0.100, about 0.001 to about 0.100, about 0.005 to about 0.100, about 0.010 to about 0.100, about 0.015 to about 0.100, about 0.020 to about 0.100, about 0.025 to about 0.100, about 0.030 to about 0.100, about 0.035 to about 0.100, about 0.040 to about 0.100, about 0.045 to about 0.100, about 0.050 to about 0.100, about 0.055 to about 0.100, about 0.060 to about 0.100, about 0.065 to about 0.100, about 0.070 to about 0.100, about 0.075 about 0.100, about 0.080 to about 0.100, about 0.085 to about 0.100, about 0.090 to about 0.100, or about 0.095 to about 0.100. In preferred embodiments, p may be from about 0.010 to about 0.070, from about 0.020 to about 0.090, or from about 0.050 to about 0.100. In other preferred embodiments, p may be greater than 0.

The solid state composition may comprise a solid electrolyte material having the formula Li₃Na_{y}PS₄Cl_{y}, Li₇Na_{y}PS₆Cl_{y}, Li₇Na_{y}P₃S₁₁Cl_{y}, Li₄Na_{y}PS₄XCl_{y}, Li₆Na_{y}PS₅XCl_{y}, Li₇Na_{y}P₂S₈XCl_{y}, or a combination thereof, wherein y is from 0 to 0.100 and wherein X is a halogen (F, Cl, Br, or I). For example, y may be about 0, 0.010, 0.020, 0.030, 0.040, 0.050, 0.060, 0.070, 0.080, 0.090, or about 0.100. In some embodiments, y may be from about 0 to about 0.010, about 0 to about 0.020, about 0 to about 0.030, about 0 to about 0.040, about 0 to about 0.050, about 0 to about 0.060, about 0 to about 0.070, about 0 to about 0.080, about 0 to about 0.090, about 0 to about 0.100, about 0.010 to about 0.100, about 0.020 to about 0.100, about 0.030 to about 0.100, about 0.040 to about 0.100, about 0.050 to about 0.100, about 0.060 to about 0.100, about 0.070 to about 0.100, about 0.080 to about 0.100, or about 0.090 to about 0.100. Preferably, the solid state composition of Formula I comprises an argyrodite crystal structure.

The solid compositions of the present disclosure may be prepared according to the following reactions:

Li₂S+P₂S₅→Li₇PS₆→Li₇PS₆+yAY→Li₇A_{y}PS₆Y_{y}

Li₂S+P₂S₅→Li₇P₃S₁₁→→Li₇P₃S₁₁+yAY→Li₇A_{y}P₃S₁₁Y_{y}

Li₂S+P₂S₅+LiX→Li₄PS₄X→Li₄PS₄X+yAY→Li₄A_{y}PS₄XY_{y}

Li₂S+P₂S₅+LiX→Li₆PS₅X→Li₆PS₅X+yAY→Li₆A_{y}PS₅XY_{y}

Li₂S+P₂S₅+LiX→Li₇P₂S₈X→Li₇P₂S₈X+yAY→Li₇A_{y}P₂S₈XY_{y}

Further provided herein are methods of preparing solid state compositions comprising mixing Li₂S, P₂S₅, LiCl, and Li₃OCl, forming a solid-state composition and heat treating the solid-state composition; wherein Y is at least one halogen selected from a group consisting of F, Cl, Br, I, and a combination thereof.

Further provided herein are solid state compositions of Formula II, made by the methods provided herein:

Li_{(3β+7-z-w)}PS_{(6-z-w)}O_{β}Cl_{(β+z)}Y_{w} (II)

where Y is a halogen selected from the group consisting of F, Cl, Br, I, and combinations thereof; z is from 0 to 2, w is from 0 to 2, z+w is from 0 to 2. In preferred embodiments, the solid-state composition of Formula II comprises an Argyrodite crystal structure.

In some embodiments, z may range from 0 to 2. For example, z may be about 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or about 2.0. In some aspects, z may be from about 0 to about 0.5, about 0 to about 1, about 0 to about 1.5, about 0 to about 2, about 0.5 to about 2, about 1 to about 2, or about 1.5 to about 2.

In some embodiments, w may range from 0 to 2. For example, w may be about 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or about 2.0. In some aspects, w may be from about 0 to about 0.5, about 0 to about 1, about 0 to about 1.5, about 0 to about 2, about 0.5 to about 2, about 1 to about 2, or about 1.5 to about 2.

In some embodiments, β may range from 0 to 0.100. For example, β may be about 0, 0.001, 0.005, 0.010, 0.015 0.020, 0.0250, 0.030, 0.0350, 0.040, 0.045, 0.050, 0.055, 0.060, 0.065, 0.070, 0.075, 0.080, 0.085, 0.090, 0.095, or about 0.100. In some aspects, β may be from about 0 to about 0.001, about 0 to about 0.005, about 0 to about 0.010, about 0 to about 0.015, about 0 to about 0.020, about 0 to about 0.0250, about 0 to about 0.030, about 0 to about 0.035, about 0 to about 0.040, about 0 to about 0.045, about 0 to about 0.050, about 0 to about 0.055, about 0 to about 0.060, about 0 to about 0.065, about 0 to about 0.070, about 0 to about 0.075, about 0 to about 0.080, about 0 to about 0.085, about 0 to about 0.090, about 0 to about 0.095, about 0 to about 0.100, about 0.001 to about 0.100, about 0.005 to about 0.100, about 0.010 to about 0.100, about 0.015 to about 0.100, about 0.020 to about 0.100, about 0.025 to about 0.100, about 0.030 to about 0.100, about 0.035 to about 0.100, about 0.040 to about 0.100, about 0.045 to about 0.100, about 0.050 to about 0.100, about 0.055 to about 0.100, about 0.060 to about 0.100, about 0.065 to about 0.100, about 0.070 to about 0.100, about 0.075 about 0.100, about 0.080 to about 0.100, about 0.085 to about 0.100, about 0.090 to about 0.100, or about 0.095 to about 0.100. In preferred embodiments, p may be from about 0.010 to about 0.070, from about 0.020 to about 0.090, or from about 0.050 to about 0.100. In other preferred embodiments, p may be greater than 0.

The solid state compositions of the present disclosure may have an X-Ray Diffraction pattern taken with Cu-Kα(1,2)=1.5418 Å with characteristic peaks at 2θ=15.7°±0.5°, 18.2°±0.5°, 25.8°±0.5°, 30.3°±0.5°, 31.6°±0.5°, and 31.8°±0.5°. In some embodiments, the peak intensity ratio between the peak at 31.6°±0.5° and the peak at 31.8°±0.5° may be greater than 5.

Further provided herein is an electrochemical cell comprising one or more compositions of Formula (I) or Formula (II) described above. The electrochemical cell comprises a positive electrode (i.e. cathode) current collector; a positive electrode layer (i.e. cathode layer) having a first side in operable contact with the cathode current collector and a second side opposite to the first side, a separator layer having a first side in operable contact with the second side of the cathode layer and a second side opposite to the first side, a negative electrode layer (i.e. anode layer) having a first side in operable contact with the second side of the separator layer, and a second side opposite to the first side, and a negative electrode (i.e. anode) current collector in operable contact with the second side of the anode layer.

The anode layer may comprise one or more anode active materials. In one embodiment, the anode active material may comprise one or more materials such as Silicon (Si), Tin (Sn), Germanium (Ge), graphite, Li₄Ti₅O₁₂ (LTO) or other known anode active materials.

In some embodiments, the anode active material may be present in the anode layer in an amount of about 30% to about 98% by weight of the anode layer. In some aspects, the anode active material may be present in the anode layer in an amount of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 98%, about 40% to about 98%, about 45% to about 98%, about 50% to about 98%, about 55% to about 98%, about 60% to about 98%, about 65% to about 98%, about 70% to about 98%, about 75% to about 98%, about 80% to about 98%, about 85% to about 98%, about 90% to about 98%, about 40% to about 90%, about 40% to about 80%, about 40% to about 70%, about 40% to about 60%, about 40% to about 55%, about 40% to about 50%, or about 40% to about 45% by weight of the anode layer.

In some embodiments, the anode layer may have a thickness from about 1 μm to about 100 μm. In some aspects, the anode layer may have a thickness of about 1 μm to about 10 μm, about 1 μm to about 20 μm, about 1 μm to about 30 μm, about 1 μm to about 40 μm, about 1 m to about 50 μm, about 1 μm to about 60 μm, about 1 μm to about 70 μm, about 1 μm to about 80 μm, about 1 μm to about 90 μm, about 10 μm to about 100 μm, about 20 μm to about 100 μm, about 30 μm to about 100 μm, about 40 μm to about 100 μm, about 50 μm to about 100 μm, about 60 μm to about 100 μm, about 70 μm to about 100 μm, about 80 μm to about 100 μm, about 90 μm to about 100 μm, about 10 μm to about 50 μm, about 20 μm to about 40 μm, or about 20 μm to about 30 μm. In some additional aspects, the anode layer may have a thickness of about 1 μm, 5 μm, 10 μm, 20 μm, 30 μm, 40 μm, 50 μm, 60 μm, 70 μm, 80 μm, 90 μm, or about 100 μm. In an exemplary embodiment, the anode layer has a thickness from about 20 μm to about 30 μm.

In some embodiments, the anode layer may optionally further comprise one or more conductive additives. The conductive additive helps to evenly distribute the charge density throughout the anode. The conductive additives may include metal powders, fibers, filaments, or any other material known to conduct electrons. In some aspects, the one or more conductive additives may include one or more conductive carbon materials such as carbon fiber, graphite, graphene, carbon black, conductive carbon, amorphous carbon, vapor grown carbon fiber (VGCF), activated carbon, and carbon nanotubes.

In some embodiments, the conductive additive may be present in the anode layer in an amount from about 0% to about 15% by weight of the anode layer. In some aspects, the conductive additive may be present in the anode layer in an amount of about 0% to about 10%, or about 0% to about 5% by weight of the anode layer. In some additional aspects, the conductive additive may be present in the anode layer in an amount of about 0%, 1%, 2%, 3%, 4%, 5%, 6%, 7%, 8%, 9%, 10%, 11%, 12%, 13%, 14%, or about 15% by weight of the anode layer. In an exemplary embodiment, the conductive additive is present in the anode layer in an amount of about 0% to about 5% by weight of the anode layer.

In some embodiments, the average particle size of the conductive additive may be about 5 nm to about 100 nm. In some aspects, the average particle size of the conductive additive may be about 5 nm to about 10 nm, about 5 nm to about 20 nm, about 5 nm to about 30 nm, about 5 nm to about 40 nm, about 5 nm to about 50 nm, about 5 nm to about 60 nm, about 5 nm to about 70 nm, about 5 nm to about 80 nm, about 5 nm to about 90 nm, about 10 nm to about 100 nm, about 20 nm to about 100 nm, about 30 nm to about 100 nm, about 40 nm to about 100 nm, about 50 nm to about 100 nm, about 60 nm to about 100 nm, about 70 nm to about 100 nm, about 80 nm to about 100 nm, about 90 nm to about 100 nm, about 10 nm to about 50 nm, or about 20 nm to about 40 nm. In some examples, the conductive additive may have a particle size of about 30 nm.

In some embodiments, the anode layer may further optionally comprise one or more solid-state electrolyte materials of the present disclosure; i.e., one or more compositions of Formula (I) or Formula (II) described herein. The solid-state electrolyte material, along with the conductive additive, helps to evenly distribute the charge density throughout the anode. The one or more solid-state electrolyte materials may additionally or alternatively comprise an oxide, oxysulfide, sulfide, halide, nitride, or any other solid-state electrolyte known in the art. In some preferred embodiments, the one or more solid-state electrolyte materials may comprise a sulfide solid-state electrolyte material, i.e., a solid-state electrolyte having at least one sulfur component. In some embodiments, the one or more solid-state electrolytes may comprise one or more material combinations such as Li₂S—P₂S₅, Li₂S—P₂S₅—LiI, Li₂S—P₂S₅—GeS₂, Li2_{S}—P₂S₅—Li₂O, Li₂S—P₂S₅—Li₂O—LiI, Li₂S— P₂S₅—LiI—LiBr, Li₂S—SiS₂, Li₂S SiS₂—LiI, Li₂S—SiS₂—LiBr, Li₂S—S—SiS₂—LiCl, Li₂S—S—SiS₂—B₂S₃—LiI, Li₂S—S SiS₂—P₂S₅—LiI, Li₂S—B₂S₃, Li₂S P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂-LiₓMO_{y} (where x and y are positive numbers, and M is P, Si, Ge, B, Al, Ga or In).

In another embodiment, the solid-state electrolyte material may be one or more of Li₃PS₄, Li₄P₂S₆, Li₇P₃S₁₁, Li₁₀GeP₂S₁₂, Li₁₀SnP₂S₁₂. In a further embodiment, the solid-state electrolyte may be an argyrodite electrolyte, such as one or more of a Li₆PS₅Cl, Li₆PS₅Br, Li₆PS₅I or expressed by the formula Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN. In yet another embodiment, the solid-state electrolyte material be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN. In additional embodiments, the solid-state electrolyte material may be a halide electrolyte. Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(6-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and Tl, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In some aspects, the solid-state electrolyte material may be present in the anode layer 102 in an amount from about 0% to about 60% by weight of the anode layer; for example, the solid-state electrolyte may be present in the anode layer in an amount from about 0% to about 10% by weight, about 0% to about 20% by weight, about 0% to about 30% by weight, about 0% to about 40% by weight, about 0% to about 50% by weight, about 10% to about 60% by weight, about 20% to about 60% by weight, about 30% to about 60% by weight, about 40% to about 60% by weight, or about 50% to about 60% by weight. In some aspects, the solid-state electrolyte material may be present in the anode layer in an amount of about 5%, 10%, 15%, 20%, 25%, 30%, 35%, 40%, 45%, 50%, 55%, or 60% by weight of the anode layer. In an exemplary embodiment, the solid-state electrolyte material is present in an amount of about 35% to about 45% by weight of the anode layer.

The anode layer may further comprise a binder. The binder aids in adhesion of the anode layer to the current collector and increases the structural integrity of the anode layer. Additionally, the binder may enable improved cohesion between like particles in different layers of an electrochemical cell (e.g., an electrolyte). The binder also forms a flexible matrix when mixed with the solid-state electrolyte material. In some embodiments, the binder may comprise fluororesin containing vinylidene fluoride (VdF), hexafluoropropylene (HFP), tetrafluoroethylene (TFE), and derivatives thereof as structural units. In some additional embodiments, the binder may comprise homopolymers such as polyvinylidene fluoride (PVdF), polyhexafluoropropylene (PHFP), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene block copolymer (SBS), styrene-isoprene block copolymer (SIS), styrene-ethylene-butylene-styrene block copolymer (SEBS), polyacrylonitrile (PAN), nitrile-butylene rubber (NBR), polybutadiene, polyisoprene, poly (methacrylate) nitrile-butadiene rubber (PMMA-NBR) and the like.

In a further embodiment, the binder may be one or more of an acrylic resin such as but not limited to polymethyl(meth)acrylate, polyethyl(meth)acrylate, polyisopropyl(meth)acrylate polyisobutyl(meth)acrylate, polybutyl(meth)acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof.

In some aspects, the binder may be present in the anode layer in an amount from about 0% to about 20% by weight of the anode layer; for example, the binder may be present in the anode layer in an amount of about 0% to about 5%, about 0% to about 10%, about 0% to about 15%, about 5% to about 20%, about 10% to about 20%, or about 15% to about 20%. In an exemplary embodiment, the binder is present in the anode layer in an amount of about 4% to about 5% by weight.

The anode layer may have a density from about 1.0 g/cm³ to about 2.0 g/cm³. In some embodiments, the first anode layer may have a density from about 1.0 g/cm³ to about 1.1 g/cm³, about 1.1 g/cm³ to about 1.2 g/cm³, about 1.2 g/cm³ to about 1.3 g/cm³, about 1.3 g/cm³ to about 1.4 g/cm³, about 1.4 g/cm³ to about 1.5 g/cm³, about 1.5 g/cm³ to about 1.6 g/cm³, about 1.6 g/cm³ to about 1.7 g/cm³, about 1.7 g/cm³ to about 1.8 g/cm³, about 1.8 g/cm³ to about 1.9 g/cm³, about 1.9 g/cm³ to about 2.0 g/cm³, about 1.0 g/cm³ to about 1.2 g/cm³, about 1.0 g/cm³ to about 1.3 g/cm³, about 1.0 g/cm³ to about 1.4 g/cm³, about 1.0 g/cm³ to about 1.5 g/cm³, about 1.0 g/cm³ to about 1.6 g/cm³, about 1.0 g/cm³ to about 1.7 g/cm³, about 1.0 g/cm³ to about 1.8 g/cm³, about 1.0 g/cm³ to about 1.9 g/cm³, about 1.1 g/cm³ to about 2.0 g/cm³, about 1.2 g/cm³ to about 2.0 g/cm³, about 1.3 g/cm³ to about 2.0 g/cm³, about 1.4 g/cm³ to about 2.0 g/cm³, about 1.5 g/cm³ to about 2.0 g/cm³, about 1.6 g/cm³ to about 2.0 g/cm³, about 1.7 g/cm³ to about 2.0 g/cm³, about 1.8 g/cm³ to about 2.0 g/cm³, or about 1.9 g/cm³ to about 2.0 g/cm³.

The cathode layer may include a cathode active material such as (“NMC”) nickel-manganese-cobalt which may be expressed as Li(NiₐCo_{b}Mn_{c})O₂(0<a<1, 0<b<1, 0<c<1, a+b+c=1) or, for example, NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or a combination thereof. In another embodiment, the cathode active material may comprise one or more of a coated or uncoated metal oxide, such as but not limited to V₂O₅, V₆O₁₃, MoO₃, LiCoO₂, LiNiO₂, LiMnO₂, LiMn₂O₄, LiNi_{1-Y}Co_{Y}O₂, LiCo_{1-Y}Mn_{Y}O₂, LiNi_{1-Y}Mn_{Y}O₂ (0≤Y<1), Li(NiₐCo_{b}Mn_{c})O₄ (0<a<2, 0<b<2, 0<c<2, a+b+c=2), LiMn_{2-Z}Ni_{Z}O₄, LiMn_{2-Z}Co_{Z}O₄(0<Z<2), LiCoPO₄, LiFePO₄, CuO, Li(NiₐCo_{b}Al_{c})O₂ (0<a<1, 0<b<1, 0<c<1, a+b+c=1) or a combination thereof. In yet another embodiment, the cathode active material may comprise one or more of a coated or uncoated metal sulfide such as but not limited to titanium sulfide (TiS₂), molybdenum sulfide (MoS₂), iron sulfide (FeS, FeS₂), copper sulfide (CuS), and nickel sulfide (Ni₃S₂) or combination thereof. In still further embodiments, the cathode active material may comprise elemental sulfur (S). In additional embodiments, the cathode active material may comprise one or more of a fluoride, such as but not limited to lithium fluoride (LiF), sodium fluoride (NaF), calcium fluoride (CaF₂), magnesium fluoride (MgF₂), nickel (II) fluoride (NiF₂), iron (III) fluoride (FeF₃), vanadium (III) fluoride (VF₃), cobalt (III) fluoride (CoF₃), chromium (III) fluoride (CrF₃), manganese (III) fluoride (MnF₃), aluminum fluoride (AlF₃), and zirconium (IV) fluoride (ZrF₄), or combinations thereof.

The cathode layer may further comprise one or more electronically conductive additives. The electronically conductive additives may include metal powders, fibers, filaments, or any other material known to conduct electrons. In some aspects, the one or more electronically conductive additives may include one or more electronically conductive carbon materials such as carbon fiber, graphite, graphene, carbon black, conductive carbon, amorphous carbon, vapor grown carbon fiber (VGCF), activated carbon, and carbon nanotubes. In some aspects, the electronically conductive additive may be present in the cathode layer in an amount of about 1% to about 10%.

The cathode layer may further comprise one or more solid-state electrolytes of the present disclosure. The one or more solid-state electrolyte may additionally or alternatively comprise an oxide, oxysulfide, sulfide, halide, nitride, or any other solid-state electrolyte known in the art. In some preferred embodiments, the one or more solid-state electrolytes may comprise a sulfide solid-state electrolyte. In some embodiments, the solid-state electrolyte comprises one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S-P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂-LiₓMO_{y} (where x and y are positive numbers, and M is P, Si, Ge, B, Al, Ga or In). In another embodiment, the solid-state electrolyte may be one or more of a Li₃PS₄, Li₄P₂S₆, Li₇P₃S₁₁, Li₁₀GeP₂S₁₂, Li₁₀SnP₂S₁₂. In a further embodiment, the solid-state electrolyte may be an argyrodite electrolyte, such as one or more of a Li₆PS₅Cl, Li₆PS₅Br, Li₆PS₅I or expressed by the formula Li_{7-y}PS_{6-y}X_{y} where “X” represents at least one halogen and/or at least one pseudo-halogen, where 0<y≤2.0, and where the at least one halogen may be one or more of F, Cl, Br, I, and the at least one pseudo-halogen may be one or more of N, NH, NH₂, NO, NO₂, BF₄, BH₄, AlH₄, CN, and SCN. In yet another embodiment, the solid-state electrolyte be expressed by the formula Li_{8-y-z}P₂S_{9-y-z}X_{y}W_{z} (where “X” and “W” represents at least one halogen elements and or pseudo-halogen and where 0≤y≤1 and 0≤z≤1) and where a halogen may be one or more of F, Cl, Br, I, and a pseudo-halogen may be one or N, NH, NH₂, NO, NO₂, BF₄, BH₄, AlH₄, CN, and SCN. In additional embodiments, the solid-state electrolyte material may be a halide electrolyte. Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(6-Ω)}, where. 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and Tl, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂. In some aspects, the solid state electrolyte may be present in the cathode layer in an amount from about 5% to about 20%.

The cathode layer may further comprise one or more of a binder. In some embodiments, the binder may include fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the binder may be one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof. In some aspects, the binder may be present in the cathode layer in an amount from about 0% to about 5%.

The cathode layer may have a density from about 1.0 g/cm³ to about 2.0 g/cm³. In some embodiments, the first anode layer may have a density from about 1.0 g/cm³ to about 1.1 g/cm³, about 1.1 g/cm³ to about 1.2 g/cm³, about 1.2 g/cm³ to about 1.3 g/cm³, about 1.3 g/cm³ to about 1.4 g/cm³, about 1.4 g/cm³ to about 1.5 g/cm³, about 1.5 g/cm³ to about 1.6 g/cm³, about 1.6 g/cm³ to about 1.7 g/cm³, about 1.7 g/cm³ to about 1.8 g/cm³, about 1.8 g/cm³ to about 1.9 g/cm³, about 1.9 g/cm³ to about 2.0 g/cm³, about 1.0 g/cm³ to about 1.2 g/cm³, about 1.0 g/cm³ to about 1.3 g/cm³, about 1.0 g/cm³ to about 1.4 g/cm³, about 1.0 g/cm³ to about 1.5 g/cm³, about 1.0 g/cm³ to about 1.6 g/cm³, about 1.0 g/cm³ to about 1.7 g/cm³, about 1.0 g/cm³ to about 1.8 g/cm³, about 1.0 g/cm³ to about 1.9 g/cm³, about 1.1 g/cm³ to about 2.0 g/cm³, about 1.2 g/cm³ to about 2.0 g/cm³, about 1.3 g/cm³ to about 2.0 g/cm³, about 1.4 g/cm³ to about 2.0 g/cm³, about 1.5 g/cm³ to about 2.0 g/cm³, about 1.6 g/cm³ to about 2.0 g/cm³, about 1.7 g/cm³ to about 2.0 g/cm³, about 1.8 g/cm³ to about 2.0 g/cm³, or about 1.9 g/cm³ to about 2.0 g/cm³.

The electrolyte layer (also referred to herein as the “separator layer”) may include one or more solid-state electrolytes of the present disclosure. The one or more solid-state electrolytes may additionally or alternatively comprise an oxide, oxysulfide, sulfide, halide, nitride, or any other solid-state electrolyte known in the art. In some preferred embodiments, the one or more solid-state electrolytes may comprise a sulfide solid-state electrolyte. In some aspects, the one or more sulfide solid-state electrolyte may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S-P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂-LiₓMO_{y} (where x and y are positive numbers, and M is P, Si, Ge, B, Al, Ga or In). In some embodiments, one or more of the solid electrolyte materials may be Li₃PS₄, Li₄P₂S₆, Li₇P₃S₁₁, Li₁₀GeP₂S₁₂, Li₁₀SnP₂S₁₂. In another embodiment, one or more of the solid electrolyte materials may be an argyrodite electrolyte such as Li₆PS₅Cl, Li₆PS₅Br, Li₆PS₅I or expressed by the formula Li_{7-y}PS_{6-y}X_{y}, where “X” represents at least one halogen and/or at least one pseudo-halogen, where 0<y≤2.0, and where the halogen may be one or more of F, Cl, Br, I, and the pseudo-halogen may be one or more of N, NH, NH₂, NO, NO₂, BF₄, BH₄, AlH₄, CN, and SCN. In another embodiment, one or more of the solid electrolyte materials may be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN. In additional embodiments, the solid-state electrolyte material may be a halide electrolyte. Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(6-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and Tl, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

The electrolyte layer may further comprise one or more of a binder. In some embodiments, the binder may include fluororesin containing vinylidene fluoride (VdF), hexafluoropropylene (HFP), tetrafluoroethylene (TFE), and derivatives thereof as structural units. Specific examples thereof may include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer, such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR) and the like. In a further embodiment, the binder may be one or more of an acrylic resin such as but not limited to polymethyl(meth)acrylate, polyethyl(meth)acrylate, polyisopropyl(meth)acrylate polyisobutyl(meth)acrylate, polybutyl(meth)acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof.

The binder may be present in the electrolyte layer in an amount from about 0% to about 40% by weight. For example, the binder may be present in the electrolyte layer in an amount of about 0% to about 5%, about 0% to about 10%, about 0% to about 15%, about 0% to about 20%, about 0% to about 25%, about 0% to about 30%, about 0% to about 35%, about 0% to about 40%, about 5% to about 40%, about 10% to about 40%, about 15% to about 40%, about 20% to about 40%, about 25% to about 40%, about 30% to about 40%, about 35% to about 40%, about 5% to about 15%, about 5% to about 20%, about 10% to about 15%, about 10% to about 20%, or about 15% to about 20% by weight.

The electrolyte layer may have a density from about 1.0 g/cm³ to about 2.0 g/cm³. In some embodiments, the first anode layer may have a density from about 1.0 g/cm³ to about 1.1 g/cm³, about 1.1 g/cm³ to about 1.2 g/cm³, about 1.2 g/cm³ to about 1.3 g/cm³, about 1.3 g/cm³ to about 1.4 g/cm³, about 1.4 g/cm³ to about 1.5 g/cm³, about 1.5 g/cm³ to about 1.6 g/cm³, about 1.6 g/cm³ to about 1.7 g/cm³, about 1.7 g/cm³ to about 1.8 g/cm³, about 1.8 g/cm³ to about 1.9 g/cm³, about 1.9 g/cm³ to about 2.0 g/cm³, about 1.0 g/cm³ to about 1.2 g/cm³, about 1.0 g/cm³ to about 1.3 g/cm³, about 1.0 g/cm³ to about 1.4 g/cm³, about 1.0 g/cm³ to about 1.5 g/cm³, about 1.0 g/cm³ to about 1.6 g/cm³, about 1.0 g/cm³ to about 1.7 g/cm³, about 1.0 g/cm³ to about 1.8 g/cm³, about 1.0 g/cm³ to about 1.9 g/cm³, about 1.1 g/cm³ to about 2.0 g/cm³, about 1.2 g/cm³ to about 2.0 g/cm³, about 1.3 g/cm³ to about 2.0 g/cm³, about 1.4 g/cm³ to about 2.0 g/cm³, about 1.5 g/cm³ to about 2.0 g/cm³, about 1.6 g/cm³ to about 2.0 g/cm³, about 1.7 g/cm³ to about 2.0 g/cm³, about 1.8 g/cm³ to about 2.0 g/cm³, or about 1.9 g/cm³ to about 2.0 g/cm³.

In some embodiments, the electrolyte layer may have a thickness from about 10 to about 40 μm. In some aspects, the electrolyte layer may have a thickness of about 10 μm to about 20 μm, about 10 μm to about 30 μm, about 20 μm to about 30 μm, about 20 μm to about m, or about 30 μm to about 40 μm. In some additional aspects, the electrolyte layer may have a thickness of about 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, or about 40 μm.

The negative electrode current collector may comprise one or more of copper, aluminum, nickel, titanium, stainless steel, magnesium, iron, zinc, indium, germanium, silver, platinum, or gold. In some embodiments, the negative electrode current collector may have a thickness from about 5 μm to about 10 μm. In some embodiments, the negative electrode current collector includes a carbon coating. In preferred embodiments, the negative electrode current collector comprises copper, nickel, and/or steel.

The positive electrode current collector may comprise one or more of copper, aluminum, nickel, titanium, stainless steel, magnesium, iron, zinc, indium, germanium, silver, platinum, or gold. In some embodiments, the negative electrode current collector may have a thickness from about 5 m to about 10 m. In some embodiments, the negative electrode current collector includes a carbon coating. In preferred embodiments, the negative electrode current collector comprises copper, nickel, and/or aluminum.

### ENUMERATED EMBODIMENTS

Embodiment 1: A solid-state composition of Formula (I):

Li_{(7-z-w)}A_{β}PS_{(6-z-w)}X_{z+β}Y_{w} (I);
wherein X and Y are independently selected from a group consisting of F, Cl, Br, and I;
A is selected from a group consisting of Na, K, Cs, Fr, and a combination thereof; and 0≤z≤2 and 0≤w≤2 where z+w≤2, and 0<β≤0.100.
Embodiment 2: The composition of embodiment 1, wherein the composition comprises an argyrodite crystal structure.
Embodiment 3: The composition of embodiment 1 or 2, wherein 0<β≤0.070.
Embodiment 4: The composition of any one of embodiments 1-3, wherein 0<β≤0.050.
Embodiment 5: The composition of any one of embodiments 1-4, wherein 0<β≤0.045.
Embodiment 6: The composition of any one of embodiments 1-5, wherein 0<β≤0.035.
Embodiment 7: The composition of any one of embodiments 1-6, wherein 0<β≤0.030.
Embodiment 8: The composition of any one of embodiments 1-7, wherein 0<β≤0.020.
Embodiment 9: The composition of any one of embodiments 1-8, wherein 0<β≤0.010.
Embodiment 10: The composition of embodiment 1 or 2, wherein 0.010≤β≤0.070.
Embodiment 11: The composition of embodiment 1 or 2, wherein 0.020≤β≤0.090.
Embodiment 12: The composition of embodiment 1 or 2, wherein 0.050≤β≤0.100.
Embodiment 13: A solid state composition comprising Li₃Na_{y}PS₄Cl_{y}, Li₇Na_{y}PS₆Cl_{y}, Li₇Na_{y}P₃S₁₁Cl_{y}, Li₄Na_{y}PS₄XCl_{y}, Li₆Na_{y}PS₅XCl_{y}, Li₇Na_{y}P₂S₈XCl_{y}, or a combination thereof, wherein X is at least one halogen selected from the group consisting of F, Cl, Br, and I, and 0<y≤0.100.
Embodiment 14: The composition of embodiment 13, wherein the composition comprises an argyrodite crystal structure.
Embodiment 15: A solid-state composition of Formula (II):

Li_{(3β+7-z-w)}PS_{(6-z-w)}O_{β}Cl_{(β+z)}Y_{w} (II);
wherein Y is at least one halogen selected from a group consisting of F, Cl, Br, I, and a combination thereof;
0≤z≤2, 0≤w≤2, z+w≤2; and,
0<β≤0.100.
Embodiment 16: The composition of embodiment 15, wherein the composition comprises an argyrodite crystal structure.
Embodiment 17: The composition of embodiment 15 or 16, wherein 0<β≤0.070.
Embodiment 18: The composition any one of embodiments 15-17, wherein 0<β≤0.050.
Embodiment 19: The composition of any one of embodiments 15-18, wherein 0<β≤0.045.
Embodiment 20: The composition of any one of embodiments 15-19, wherein 0<β≤0.035.
Embodiment 21: The composition of any one of embodiments 15-20, wherein 0<β≤0.030.
Embodiment 22: The composition of any one of embodiments 15-21, wherein 0<β≤0.020.
Embodiment 23: The composition of any one of embodiments 15-22, wherein 0<β≤0.010.
Embodiment 24: The composition of embodiment 15 or 16, wherein 0.010≤β≤0.070.
Embodiment 25: The composition of embodiment 15 or 16, wherein 0.020≤β≤0.090.
Embodiment 26: The composition of embodiment 15 or 16, wherein 0.050≤β≤0.100.
Embodiment 27: A solid state composition comprising Li_{(3+3y)}PS₄O_{y}Cl_{y}, Li_{(7+3y)}PS₆O_{y}Cl_{y}, Li_{(7+3y)}P₃S₁₁O_{y}Cl_{y}, Li_{(4+3y)}PS₄O_{y}XCl_{y}, Li_{(6+3y)}PS₅O_{y}XCl_{y}, Li_{(7+3y)}P₂S₈O_{y}XCl_{y}, or a combination thereof, wherein X is at least one halogen selected from the group consisting of F, Cl, Br, and I, and 0<y≤0.100.
Embodiment 28: The composition of embodiment 27, wherein the composition comprises an argyrodite crystal structure.
Embodiment 29: A method of preparing a solid-state composition, comprising contacting Li₂S, P₂S₅, LiCl, and an alkali metal salt (AY) thereby forming a solid-state composition; and heat treating the solid-state composition, wherein the composition comprises an argyrodite crystal structure.
Embodiment 30: A method of preparing a solid-state composition, comprising contacting Li₂S, P₂S₅, LiCl, and Li₃OCl, thereby forming a solid-state composition; and heat treating the solid-state composition, wherein the composition comprises an argyrodite crystal structure.
Embodiment 31: An electrochemical cell comprising a composition of any one of claims 1-28.
Embodiment 32: An electrochemical cell comprising:
a positive electrode current collector;
a positive electrode layer having a first side in operable contact with the positive electrode current collector and a second side opposite to the first side;
a separator layer having a first side in operable contact with the second side of the cathode layer and a second side opposite to the first side, the separator layer comprising a composition of any one of embodiments 1-28;
a negative electrode layer having a first side in operable contact with the second side of the separator layer and a second side opposite to the first side; and
a negative electrode current collector in operable contact with the second side of the negative electrode layer.

### EXAMPLES

### Comparative Example 1

Li₂S, P₂S₅ and LiCl were combined in a molar ratio of 5:1:2 to form a composite mixture. This composite mixture was heated to 450° C. for 1 hour. The resulting electrolyte material was a Li₆PS₅Cl material with an Argyrodite crystal structure. When measured by X-Ray Diffraction (XRD) taken with Cu-Kα(1,2)=1.5418 Å, the material had peak positions at 2θ=15.7°, 18.2°, 25.8°, 30.3°, and 31.6°.

### Example 1

An Aliquot of the electrolyte material prepared in Comparative Example 1 was mixed with NaCl to form a composite of 95 wt % Li₆PS₅Cl and 5% NaCl. This composite has the formula Li₆Na_{0.24}PS₅Cl_{1.24}. When measured by X-Ray Diffraction (XRD) taken with Cu-Kα(1,2)=1.5418 Å, the material had peak positions at 2θ=15.7°, 18.2°, 25.8°, 30.3°, 31.6°, and 31.8°. The peak intensity ratio between the peak at 31.6° and 31.8° was greater than 5.

### Example 2

An Aliquot of the electrolyte material of Comparative Example 1 was mixed with NaCl to form a composite of 90 wt % Li₆PS₅Cl and 10% NaCl. This composite had the formula Li₆Na_{0.51}PS₅Cl_{1.51}.

When measured by X-Ray Diffraction (XRD) taken with Cu-Kα(1,2)=1.5418 Å, the material had peak positions at 2θ=15.7°, 18.2°, 25.8°, 30.3°, 31.6°, and 31.8°.

### Dry Room Exposure

Aliquots of the material produced in Comparative Example 1, Example 1, and Example 2 were placed in separate open containers. These containers were then placed in a Dry Room for 1 hour. The Dry Room had an average dewpoint of −55° C. for the duration of the test.

As shown in Table 1, the Ioninc Conductivity of the electrolyte marked Comparative Example 1, had a 14.95% drop after the 1 hour Dry Room (DR) exposure. However, the Ioninc Conductivity of the electrolyte composite marked Example 1, had a 0.00% drop after the 1 hour Dry Room (DR) exposure. This suggests that by incorporating an alkali metal salt such as NaCl into an electrolyte composite, the Dry Room Stability of the composite can be increased.

TABLE 1

| | | Ionic | Ionic | Change in |
|---|---|---|---|---|
| | | Conductivity | Conductivity | Ionic |
| | Amount | Before DR | After DR | Conductivity |
| Example | of NaCl | Exposure (mS) | Exposure (mS) | (%) |
| Comparative | 0 | 1.94 | 1.65 | 14.95 |
| Example 1 | | | | |
| Example 1 | 0.24 | 1.26 | 1.26 | 0.00 |
| Example 2 | 1.51 | 1.34 | 1.07 | 20.15 |

Features described above as well as those claimed below may be combined in various ways without departing from the scope hereof. It should thus be noted that the matter contained in the above description or shown in the accompanying drawings should be interpreted as illustrative and not in a limiting sense.

What is claimed is:

1. A solid-state composition of Formula (I):
Li_{(7-z-w)}A_{β}PS_{(6-z-w)}X_{z+β}Y_{w} (I);
wherein X and Y are independently selected from a group consisting of F, Cl, Br, and I;
A is selected from a group consisting of Na, K, Cs, Fr, and a combination thereof; and
0≤z≤2 and 0≤w≤2 where z+w≤2, and 0<β≤0.100.

2. The composition of claim 1, wherein the composition comprises an argyrodite crystal structure.

3. The composition of claim 1, wherein 0<β≤0.070.

4. The composition of claim 1, wherein 0<β≤0.035.

5. The composition of claim 1, wherein 0<β≤0.010.

6. The composition of claim 1, wherein 0.010≤β≤0.070.

7. The composition of claim 1, wherein 0.020≤β≤0.090.

8. The composition of claim 1, wherein 0.050≤β≤0.100.

9. A solid state composition comprising Li₃Na_{y}PS₄Cl_{y}, Li₇Na_{y}PS₆Cl_{y}, Li₇Na_{y}P₃S₁₁Cl_{y}, Li₄Na_{y}PS₄XCl_{y}, Li₆Na_{y}PS₅XCl_{y}, Li₇Na_{y}P₂S₈XCl_{y}, or a combination thereof, wherein X is at least one halogen selected from the group consisting of F, Cl, Br, and I, and 0<y≤0.100.

10. The composition of claim 9, wherein the composition comprises an argyrodite crystal structure.

11. A solid-state composition of Formula (II):
Li_{(3β+7-z-w)}PS_{(6-z-w)}O_{β}Cl_{(β+z)}Y_{w} (II);
wherein Y is at least one halogen selected from a group consisting of F, Cl, Br, I, and a combination thereof;
0≤z≤2, 0≤w≤2, z+w≤2; and,
0<β≤0.100.

12. The composition of claim 11, wherein the composition comprises an argyrodite crystal structure.

13. The composition of claim 11, wherein 0<β≤0.070.

14. The composition of claim 11, wherein 0<β≤0.035.

15. The composition of claim 11, wherein 0<β≤0.010.

16. The composition of claim 11, wherein 0.010≤β≤0.070.

17. The composition of claim 11, wherein 0.020≤β≤0.090.

18. The composition of claim 11, wherein 0.050≤β≤0.100.

19. An electrochemical cell comprising the composition of claim 1.

20. An electrochemical cell comprising the composition of claim 11.
